(19) United States
(12) Patent Application Publication
(10) Pub. No.: US 2026/0350735 A1
(43) Pub. Date: Nov. 5, 2026

(54) AUTOMATED SYSTEM FOR SAFETY VIOLATION DETECTION AND CORRECTIVE ACTION VERIFICATION

(71) Applicant: Ravi PRASHER, Vaughan (CA)

(72) Inventor: Ravi PRASHER, Vaughan (CA)

(21) Appl. No.: 19/194,540

(22) Filed: Apr. 30, 2025

(51) Int. Cl. G06Q 50/26; G08B 21/18

(52) U.S. Cl. CPC G06Q 50/265; G08B 21/182

(57) ABSTRACT

The present disclosure relates to a system and method for monitoring a monitored environment. The system receives, from at least one sensor deployed in a monitored environment, first data. The system detects, by processing the first data, a first state. In response to detecting the first state, the system: stores, in a database, an indicator, the indicator being set to have a first value; and sends, to a computing device, a first signal. The system receives, from the at least one sensor, second data. The system detects, by processing the second data, a progression from the first state to a second state. In response to detecting the progression, the system sets, in the database, the indicator to have a second value; and sends, to the computing device, a second signal.

### FIELD

The present disclosure is related to a system and method for real-time surveillance. In particular, the present disclosure is related to detecting safety violations and verifying that corrective actions have been taken. Implementation of the system may involve or employ, artificial intelligence (AI) techniques or models including machine learning (ML), generative artificial intelligence (genAI), large language models (LLMs), multimodal LLMs (MLLMs), and computer-vision.

### BACKGROUND

Automated alert systems and/or safety monitoring systems are used to detect safety violations. For example, an automated alert system may be used to detect a blocked emergency exit, a tripping hazard, or incorrect use of personal protective equipment (PPE). Traditionally, automated alert systems and/or safety monitoring systems generate alerts for violations of safety guidelines or protocols and require manual intervention to verify that the violations have been remedied, or corrected, and close the generated alerts. Manual intervention to verify that violations have been remedied may be subject to human error. Additionally or alternatively, manual intervention may cause alert fatigue which may increase the likelihood of human error. Human error may lead to incomplete documentation of timing of the resolution of the violation or risk repeated violations due to inadequate correction tracking.

### BRIEF DESCRIPTION OF THE DRAWINGS

Reference will now be made, by way of example, to the accompanying drawings which show example embodiments of the present application, and in which:

FIG. 1 is a diagram illustrating an example environment for detecting safety violations, or alert conditions, and generating and closing alerts in response thereto.

FIG. 2 is a block diagram illustrating an example computing device.

FIG. 3 is a block diagram illustrating an example computer system for monitoring a monitored environment, detecting safety violations, and generating and closing alerts in response thereto.

FIG. 4 shows, in flowchart form, a simplified method for generating and closing alerts in response to detecting safety violations or alert conditions.

FIG. 5 shows, in flowchart form, a simplified method for recording detections and resolutions of safety violations or alert conditions.

FIG. 6A shows an example template for example database entries for monitoring and tracking safety violations or alert conditions.

FIG. 6B shows example database entries according to the example template in FIG. 6A.

FIG. 7A shows another example template for example database entries for monitoring and tracking safety violations or alert conditions.

FIG. 7B shows example database entries according to the example template in FIG. 7A.

FIGS. 8A-8C show user interface elements for an alert management system being displayed on a computing device.

FIGS. 9A and 9B shows user interface elements for another alert management system being displayed on another computing device.

Similar reference numerals may have been used in different figures to denote similar components.

### DESCRIPTION OF EXAMPLE EMBODIMENTS

In an aspect, the present application discloses a computer-implemented method. The method comprises: receiving, from at least one sensor deployed in a monitored environment, contextual data; determining, based on the contextual data, a context; determining, based on the context, a plurality of states associated with the context; receiving, from the at least one sensor, first data; and detecting, by processing the first data, a first state of the plurality of states. The method further comprises, in response to detecting the first state: storing, in a database, an indicator, the indicator being set to have a first value; and sending, to a computing device, a first signal, the first signal causing the computing device to display a first interface element indicating that the indicator has the first value. Th method further comprises: receiving, from the at least one sensor, second data; and detecting, by processing the second data, a progression from the first state to a second state of the plurality of states. The method further comprises, in response to detecting the progression from the first state to the second state: setting, in the database, the indicator to have a second value; and sending, to the computing device, a second signal, the second signal causing the computing device to display a second interface element indicating that the indicator has the second value.

In some implementations, determining the context further comprises providing at least a portion of the contextual data to a machine learning model that has been trained to determine the context.

In some implementations, processing the first data further comprises providing at least a portion of the first data to a machine learning model that has been trained to detect the first state.

In some implementations, the method further comprises, prior to receiving the first data, using a plurality of data pairs to train the machine learning model, one of the plurality of data pairs including a sample dataset and a sample value corresponding to the sample dataset.

In some implementations, the method further comprises, prior to receiving the first data, using a plurality of data pairs to train the machine learning model, one of the plurality of data pairs including a first sample dataset corresponding to a first sample value and a second sample dataset corresponding to a second sample value.

In some implementations, the first data further comprises using a computer-vision application to detect the first state based on the first data.

In some implementations, the at least one sensor includes a wearable sensor.

In some implementations, the context corresponds to monitoring of an emergency exit and the first state corresponds to blockage of the emergency exit.

In some implementations, the context corresponds to monitoring of a walkway and the first state corresponds to a presence of a tripping hazard in the walkway.

In some implementations, the context corresponds to monitoring of personal protective equipment and the first state corresponds to incorrect configuration of the personal protective equipment.

In some implementations, the method further comprises: storing, in response to detecting the first state, in the database and in association with the first state, a first timestamp; storing, in response to detecting the second state, in the database and in association with the second state, a second timestamp; retrieving, subsequent to storing the second timestamp, the first timestamp and the second timestamp from the database; and generating a report using the first timestamp and the second timestamp.

In another aspect, the present application discloses a computer system. The computer system comprises a processor and a memory coupled to the processor. The memory stores computer-readable instructions that, when executed by the processor, configure the processor to: receive, from at least one sensor deployed in a monitored environment, contextual data; determine, based on the contextual data, a context; determine, based on the context, a plurality of states associated with the context; receive, from the at least one sensor, first data; and detect, by processing the first data, a first state of the plurality of states. The instructions further configure the processor to, in response to detecting the first state: store, in a database, an indicator, the indicator being set to have a first value; and send, to a computing device, a first signal, the first signal causing the computing device to display a first interface element indicating that the indicator has the first value. The instructions further configure the processor to: receive, from the at least one sensor, second data; and detect, by processing the second data, a progression from the first state to a second state of the plurality of states. The instructions further configure the processor to, in response to detecting the progression from the first state to the second state: set, in the database, the indicator to have a second value; and send, to the computing device, a second signal, the second signal causing the computing device to display a second interface element indicating that the indicator has the second value.

In some implementations, the instructions further configure the processor to determine the context by providing at least a portion of the contextual data to a machine learning model that has been trained to determine the context.

In some implementations, the instructions further configure the processor to process the first data by providing at least a portion of the first data to a machine learning model that has been trained to detect the first state.

In some implementations, the instructions further configure the processor to, prior to receiving the first data, use a plurality of data pairs to train the machine learning model, one of the plurality of data pairs including a first sample dataset corresponding to a first sample value and a second sample dataset corresponding to a second sample value.

In some implementations, the instructions further configure the processor to, prior to receiving the first data, use a plurality of data pairs to train the machine learning model, one of the plurality of data pairs including a first sample dataset corresponding to a first sample value and a second sample dataset corresponding to a second sample value.

In some implementations, the instructions further configure the processor to use a computer-vision application to detect the first state based on the first data.

In some implementations, the at least one sensor includes a wearable sensor.

In some implementations, the instructions further configure the processor to: store, in response to detecting the first state, in the database and in association with the first state, a first timestamp; store, in response to detecting the second state, in the database and in association with the second state, a second timestamp; retrieve, subsequent to storing the second timestamp, the first timestamp and the second timestamp from the database; and generate a report using the first timestamp and the second timestamp.

In another aspect, the present application discloses a non-transitory computer-readable storage medium. The computer-readable medium stores computer readable instructions that when, executed by a processor, configure the processor to: receive, from at least one sensor deployed in a monitored environment, contextual data; determine, based on the contextual data, a context; determine, based on the context, a plurality of states associated with the context; receive, from the at least one sensor, first data; and detect, by processing the first data, a first state of the plurality of states. The instructions further configure the processor to, in response to detecting the first state: store, in a database, an indicator, the indicator being set to have a first value; and send, to a computing device, a first signal, the first signal causing the computing device to display a first interface element indicating that the indicator has the first value. The instructions further configure the processor to: receive, from the at least one sensor, second data; and detect, by processing the second data, a progression from the first state to a second state of the plurality of states. The instructions further configure the processor to, in response to detecting the progression from the first state to the second state: set, in the database, the indicator to have a second value; and send, to the computing device, a second signal, the second signal causing the computing device to display a second interface element indicating that the indicator has the second value.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrases “at least one of . . . and . . . ” is intended to cover any one or more of the listed elements, including any one of the listed elements alone, any sub-combination, or all of the elements, without necessarily excluding any additional elements, and without necessarily requiring all of the elements. Similarly, the phrase “at least one of . . . or . . . ” is also intended to cover any one or more of the listed elements, including any one of the listed elements alone, any sub-combination, or all of the elements, without necessarily excluding any additional elements, and without necessarily requiring all of the elements.

The present disclosure relates to a computer system, surveillance system, a monitoring system, and/or an alert management system. The system may monitor a monitored environment such as, for example, an industrial facility, a healthcare facility, an educational facility, a commercial facility, chemical facility, an office building, a factory, a laboratory, a power plant, a construction site, or a workshop. The system may also be context-aware. For example, the system may be able to determine the context of the environment that it is monitoring (e.g. an emergency exit, a hallway, PPE use). The system may detect safety violations or alert conditions such as, for example, blockage of an emergency exit, a tripping hazard, or incorrect use of PPE. The system may, in response thereto, generate or open an alert. Further, the system may subsequently detect or determine that the safety violation or alert condition has been remedied, corrected, or otherwise resolved. In response thereto, the system may close the alert. The system may employ AI for the purposes of detecting safety violations and remedies thereof. For example, the system may use a ML model, a genAI model, a LLM, a MLLM, or computer-vision application to detect safety violations and resolutions thereof.

The system may further use timestamping to record a time of detecting the safety violation or alert condition. The system may also use timestamping to record a time of remedy, correction, or resolution of the safety violation or alert condition. The system may further generate a report based on the recorded data.

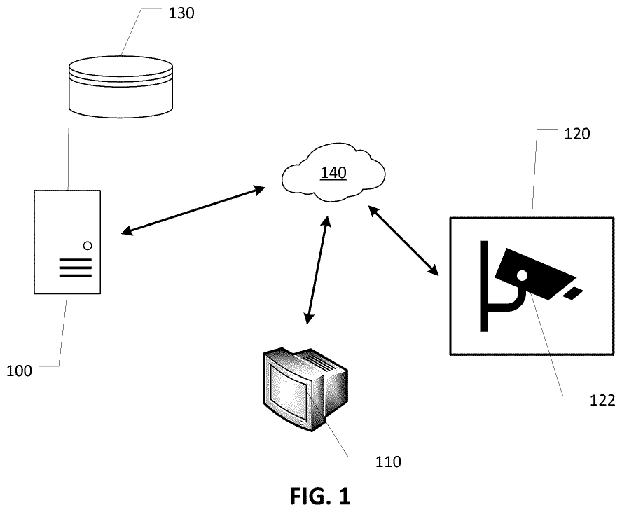

Reference is made to FIG. 1 which illustrates an example computing environment for monitoring a monitored environment, detecting safety violations or alert conditions, or generating and closing alerts in response thereto. As shown in FIG. 1, the computing environment may include a computer system 100 (depicted as a server), a computing device 110 (depicted as a desktop computer), a monitoring system 120, a database 130 coupled to the computer system 100, and at least one network 140 connecting the computer system 100, the computing device 110, and the monitoring system 120. The monitoring system 120 may include a sensor system 122 (depicted as a security camera).

The sensor system 122 may include, without limitation, cameras, image capturing devices, video capturing devices, depth sensing devices, computer-vision cameras with depth sensing, audio recorders, heat sensors, temperature sensors, infrared sensors, moisture sensors, pressure sensors, smoke sensors, air quality sensors, chemical sensors, light sensors, touch sensors, motion sensors, proximity sensors, capacitive proximity sensors, inductive proximity sensors, ultrasonic proximity sensors, optical sensors, hall effect sensors, and radio frequency identification (RFID) readers. The sensors of the sensor system may be deployed in, on, or around the monitored environment. The computer system may detect safety violations or alert conditions such as blockage of an emergency exit, a tripping hazard, or incorrect use of PPE based on data obtained from the sensor system 122. For example, the computer system 100 may detect or determine, based on data received from the cameras and/or proximity sensors of the sensor system 122 that a first emergency exit is blocked. Further, the computer system 100 may detect or determine that the first emergency exit is blocked based on multiple modalities. For example, the computer system 100 may detect or determine that the first emergency exit is blocked based on both image data from a camera and sound wave data from an ultrasonic proximity sensor.

The sensor system 122 may also comprise wearable devices such as wearable PPE detection sensors. For example, the sensor system 122 may include smart glasses or a smart helmet worn by a construction worker. The smart glasses and/or smart helmet may detect whether the construction worker is wearing PPE correctly. Additionally or alternatively, the PPE of the construction worker may be embedded with RFID tags which may in turn communicate with wearable sensors or RFID readers to determine the presence of the PPE.

In some embodiments, the monitoring system 120 may have a monitoring computer system that communicates data from the sensor system 122 to the computer system 100 via the network 140. In other embodiments, the sensor system 122 may communicate directly with the computer system 100 via the network 140. Further, in some embodiments, a first sensor of the sensor system 122 may be coupled to the computer system 100 without connecting via the network 140 and a second sensor of the sensor system 122 may only connect or send data to the computer system 100 via the network 140. For example, a security camera may be coupled to the computer system 100 and send data, for example via physical wires, to the computer system 100 whereas a wearable sensor may not be coupled to the computer system 100 and send data to the computer system 100 via the network 140 (perhaps through the monitoring computer system).

While FIG. 1 depicts the monitoring system 120 as separate from the computer system 100, in some embodiments, the monitoring system 120 may be part of or integrated with the computer system 100. In such embodiments, the sensor system 122 or sensors therein (such as cameras) may be coupled to the computer system 100.

The database 130 may record or store data relating to safety violations or alert conditions. For example, upon detecting a safety violation or alert condition, the computer system 100 may record, in the database 130, a first timestamp corresponding to detection of the safety violation or alert condition. Upon detecting remedy, correction, or resolution of the safety violation of alert condition, the computer system 100 may record, in the database 130, a second timestamp corresponding to the remedy, correction, or resolution. The computer system 100 may further record in the database 130, a status or indicator for the safety violation or alert condition. For example, a safety violation or alert condition may have a status of “active,” 1, or “open” to indicate that the safety violation or alert condition has not been resolved. On the other hand, a safety violation or alert condition may have a status of “inactive,” 0, or “closed” to indicate that the safety violation or alert condition has been resolved. In some embodiments, the database 130 may be part of the computer system 100. In other embodiments, the database 130 may be coupled to the computer system 100 via a wireless network.

The computer system 100 may maintain an application for managing alerts corresponding to detect safety violations or alert conditions. The application may be installed on the computing device 110 and the computing device 110 may access data relating to the detected safety violations or alert conditions via the application. For example, the application may cause the computer system 100 to 1) retrieve data from the database 130 relating to detected safety violations or alert conditions, and 2) present the data on a user interface displayed on the computing device 110.

In some embodiments, upon detecting a safety violation or alert condition the computer system 100 may send a message or notification to the computing device 110. The message or notification may describe the detected safety violation or alert condition. For example, the message or notification may read “Emergency exit 1 is blocked” or “Safety gloves not detected.” Similarly, the computer system 100 may, upon detecting remedy, correction, or resolution of the safety violation of alert condition, send a corresponding message or notification to the computing device 110. For example, the corresponding message or notification may read “Emergency exit 1 unblocked” or “Safety gloves detected.”

Further, in some embodiments, the computer system 100 may be context-aware. That is, the computer system may determine the type or context of the monitored environment based on data received from the sensor system 122. For example, the computer system may determine that the monitored environment is an emergency exit based on image data received from a camera. In another example, the computer system may determine, based on data received from wearable PPE sensors, that the monitored environment is related to PPE compliance. The context-awareness of the computer system 100 allow the computer system 100 to be used across multiple kinds of multiple environments. For example, the computer system 100 may be used to monitor emergency exits, hallways, and/or PPE configurations.

While FIG. 1 illustrates the computing device 110 as a desktop computer, in other embodiments, the computing device 110 may be any kind of computing device including, without limitation, handheld devices, wearable devices, smartphones, tablets, and smart glasses.

Further, while FIG. 1 illustrates one computing device 110, in other embodiments, the computing environment may comprise more such devices. For example, in some embodiments, the computing environment may comprise two such computing devices. Further, in embodiments with multiple such computing devices, the computing devices may be of different types. For example, the computing environment may comprise a first such computing device that is a desktop computer wherein a supervisor of, for example, building security, uses the desktop computer to monitor building security from a security room. In this example, the computing environment may also comprise a second such computing device that is a handheld device used by a mobile security officer within the building.

The network 140 connects the computer system 100, the computing device 110, and the monitoring system 120, or the systems included therein. The network 140 may be a cellular network such as a Wi-Fi network, a local area network (LAN), a wide area network (WAN), a 5G network, or a combination thereof.

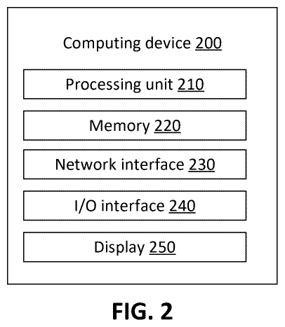

Reference is now made to FIG. 2 which illustrates an example computing device 200. In some embodiments, the computing device 200 may be exemplary of the computing device 110 (see FIG. 1). Example components of the computing device 200 are now described, which are not intended to be limiting. It should be understood that there may be different implementations of the computing device 200.

The computing device may include at least one processing unit 210 such as a processor, microprocessor, an application-specific integrated circuit (ASIC), a field-programmable gate array (FGPA), a dedicated logic circuitry, a graphics processing unit (GPU), a central processing unit (CPU), a dedicated artificial intelligence processor unit, or combinations thereof.

The computing device 200 may include at least one memory 220, which may include a volatile or non-volatile memory (e.g. a flash memory, a random access memory (RAM), and/or a read-only memory (ROM)). The memory 220 may store instructions for execution by the processing unit 210.

The computing device 200 includes at least one network interface 230 for wired or wireless communication with an external system or network (e.g., a push-to-talk (PTT) network, cellular network, an intranet, the Internet, a P2P network, a WAN, a LAN), and in particular, for communication with a computer system monitoring an environment such as the computer system 100 (see FIG. 1).

The computing device 200 may also include at least one input/output (I/O) interface 240, which interfaces with input and output devices. In some examples, the same component may serve as both an input and output device (e.g., a display 250 may be a touch-sensitive display). The computing device 200 may include other input devices (e.g., buttons, microphone, touchscreen, keyboard, etc.) and other output devices (e.g., speaker, vibration unit, etc.).

The computing device 200 may also include a display 250. In some embodiments, if an alert management application is running on the computing device 200, the display 250 may present a user interface showing alerts and data associated thereof including, without limitation, statuses, indications, messages, notifications, and timestamps.

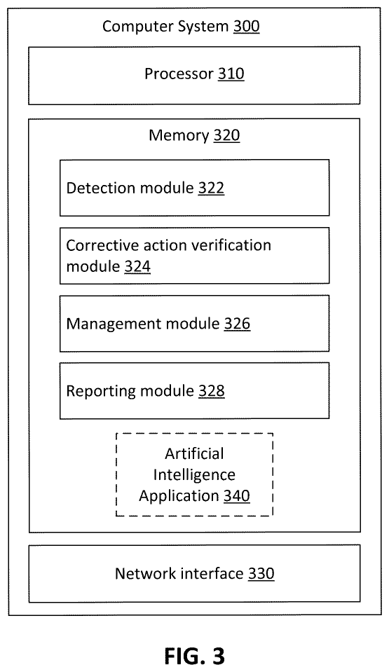

Reference is now made to FIG. 3 which illustrates an example computer system 300 for monitoring an environment and generating and closing alerts for detected safety violations or alert conditions. The computer system 300 may be exemplary of the computer system 100 (see FIG. 1). As shown in FIG. 3, the computer system 100 may include at least one processor 310 and a memory 320. The at least one processor 310 may be a central processing unit, a microprocessor, a signal processor, an ASIC, a FGPA, a dedicated logic circuitry, a dedicated artificial intelligence processor unit, a GPU, a tensor processing unit (TPU), a neural processing unit (NPU), a hardware accelerator, or combinations thereof. The memory 320 may include volatile or non-volatile memory (e.g. a flash memory, a RAM, and/or a ROM). The memory 320 may be considered a non-transitory computer-readable storage medium storing computer-executable instructions or a memory storing computer-executable instructions. The memory 320 may store instructions for execution by the at least one processor 310. The memory 320 may be coupled to the at least one processor 310.

Although FIG. 3 shows a single instance of each component, there may be multiple instances of each component in the computer system 300. Further, although the computer system 30 is illustrated as a single block, the computer system 300 may be a single physical machine or device (e.g. implemented as a single computing device, such as a single workstation, single end user device, single server, etc.), or may comprise a plurality of physical machine or devices (e.g., implemented as a server cluster). For example, the computer system 300 may represent a group of servers or cloud computing platform providing a virtualized pool of computing resources (e.g., a virtual machine or virtual server).

The memory 320 may contain software, programming, or computer-executable instructions which, when executed by the processor 310, perform various surveillance and alert management functions. In the embodiment illustrated in FIG. 3, the memory 320 stores a detection module 322, a corrective action verification module 324, a management module 326, and a reporting module 328.

The detection module 312 may comprise instructions that allow the processor 310 to detect a safety violation or alert condition. The processor 310 may detect the safety violation or alert condition by analyzing or processing data obtained from a sensor system such as the sensor system 122 (see FIG. 1). Further, the processor 310 may analyze or process the data from the sensor system in real-time. That is, the processor 310 may detect safety violations or alert condition in real-time.

Data obtained from the sensor system may include image and video data from cameras, image capturing devices, or video capturing devise, depth data from depth capturing devices such as depth sensing cameras, infrared data from infrared sensors or other infrared capturing devices, audio data from audio recorders, temperature or heat data from heat sensors or temperature sensors, moisture data from moisture sensors, pressure data from pressure or touch sensors, light or optic data from light sensors or optic sensors, chemical data from smoke sensors or other chemical sensors such as air quality sensors, motion data from motion sensors, RFID data from RFID readers, proximity data from proximity sensors such as capacitive proximity sensors, inductive proximity sensors, ultrasonic proximity sensors, and hall effect sensors. For example, the processor 310 may may detect that an emergency exit is blocked based on sound wave data captured by a ultrasonic proximity sensor. Additionally or alternatively, the processor 310 may detect that a worker is missing PPE based on data obtained from a RFID reader.

In some embodiments, the processor 310 may detect a safety violation or alert condition using video analytics or image analysis on video or images received from cameras. For example, the processor 310 may use video analytics or computer-vision to detect a tripping hazard in a hallway.

Further, in some embodiments, the detection module 322 may comprise instructions that allow the processor 310 to detect or determine, based on data obtained from the sensor system, a context for the monitored environment. For example, the processor 310 may determine that the monitored environment relates to an emergency exit or, in different wording, has an “emergency exit” context. Likewise, the processor 310 may determine that the monitored environment relates to PPE or has a PPE context. The ability to determine a context for the monitored environment enables the computer system 300 to be used to detect safety violations or alert conditions across multiple contexts.

In some embodiments, the processor 310 may use at least one AI application 340 to 1) detect safety violations or alert conditions and/or 2) determine a context for the monitored environment. The at least one AI application 340 may include a ML model, a genAI model, a LLM, a MLLM, or a computer-vision application or program. In some embodiments, the at least one AI application 340 may be stored internally in the computer system 300. In other embodiments, the at least one AI application 340 may be stored externally. For example, the at least one AI application 340 may be stored in an external server managed by a third party such as a cloud computing service. In some embodiments, the processor 310 may make calls to the at least one AI application 340 to detect safety violations or alert conditions. The at least one AI application 340 may detect safety violations or alert conditions based on sensor data such as camera footage.

In some embodiments, the at least one AI application 340 may include a trained ML model or a pre-existing ML model that has been fine-tuned. In some embodiments, the ML model may be trained or fine-tuned using paired data wherein at least some of the pairs comprise example sensor data and a corresponding indication of a safety violation or alert condition. In a specific example, one of the pairs may be, on one hand, data from a depth sensing camera showing an emergency exit being blocked by a mannequin and, on the other hand, a label indicating that the emergency exit is blocked. Additionally or alternatively, the ML model may be trained or fine-tuned using paired data wherein at least some of the pairs comprise example sensor data and a corresponding indication of an absence of a safety violation or alert condition (i.e. normalcy). In a specific example, one of the pairs may be, on one hand, data from a depth sensing camera showing an unblocked emergency exit and, on the other hand, a label indicating that the emergency exit is unblocked (or in a normal or expected state). It should be appreciated that the ML model may be trained or fine-tuned using multiple modalities of data. For example, in the case of labelled or paired data, the data corresponding to a blocked emergency exit may comprise data from an depth sensing camera and data from an ultrasonic proximity sensor.

Likewise, the at least one AI application 340 may include a ML model that has been trained for fine-tuned to determine a context for the monitored environment. In some embodiments, the ML model may be trained or fine-tuned using paired data wherein at least some pairs comprise example sensor data (contextual data) and a corresponding indication of a context. In a specific example, one of the pairs may be, on one hand, data from a camera showing an emergency exit and, on the other hand, a label such as “emergency exit.”

In some embodiments, the at least one AI application 340 may include a LLM that outputs text. For example, upon determining that an emergency exit, say Emergency Exit 1, is blocked, the LLM may output “Emergency Exit is blocked.”

In some embodiments, the at least one AI application 340 may include multiple AI models trained or fine-tuned for detecting specific safety violations or alert conditions. For example, the at least one AI application 340 may include a first ML model for detecting blockage or an emergency exit and a second ML model for detecting tripping hazards. In another example, the at least one AI application may include a first ML model for determining context of the monitored environment and additional corresponding ML models for the determined context. Further, in some embodiments, the at least one AI application 340 may include multiple AI models trained or fine-tuned for detecting safety violations or alert conditions at a specific location. For example, the at least one AI application 340 may include a first ML model for detecting blockage of a first emergency exit and a second ML model for detecting blockage of a second emergency exit. Further, in some embodiments, the at least one AI application 340 may include multiple AI models trained or fine-tuned for detecting specific safety violations or alert conditions at a specific location. It should be appreciated that while the at least one AI application 340 may include multiple AI models, in some embodiments, the at least one AI application 340 may comprise a single AI model. In such an embodiment, the single AI model may have the capabilities to determine context and detect safety violations or alert conditions for the determined context.

The corrective action verification module 324 may comprise instructions that allow the processor 310 to detect or determine that a detected safety violation or alert condition has been remedied, corrected, or resolved. Similar to detecting safety violations or alert conditions, the processor 310 may detect remedy, correction, or resolution thereof by analyzing or processing data obtained from the sensor system. Likewise, the processor 310 may analyze or process the data from the sensor system in real-time. That is, the processor 310 may detect safety violations or alert condition in real-time. Further, the processor 310 may access or use the at least one AI application 340 to detect remedy, correction, or resolution of a detected safety violation or alert condition.

The management module 326 may comprise instructions that allow the processor 310 to manage alerts corresponding to detected safety violations or alert conditions. For example, in response to detecting a safety violation, the processor 310 may generate and store, in a database such as the database 130, a timestamped database entry corresponding to the safety violation (see FIG. 1). The timestamped database entry may include, without limitation, a description, label, classification, or code corresponding to the detected safety violation, a timestamp corresponding to the detection of the safety violation, and an indicator or variable indicating that the alert or safety violation is active. Further, in response to detecting resolution of the safety violation, the processor 301 may update the timestamped database entry. For example, the timestamped database entry may be updated by 1) adding a second timestamp corresponding to detection of resolution of the safety violation and 2) modifying the indicator or variable to indicate that the alert or safety violation is inactive or resolved.

The management module 326 may further comprise instructions that allow the processor 310 to manage or maintain an application for alerts. For example, the processor 310 may maintain an application installed on a computing device such as the computing device 110 (see FIG. 1). The application may cause the processor 310 or the computing device to retrieve, from the database, data corresponding to detected safety violations or alert conditions. The application may further cause the computing device to present the retrieved data on a user interface on a display of the computing device.

The management module 326 may further comprise instructions that allow the processor 310 to send messages or notifications to a computing device such as the computing device 110. In some embodiments, the processor 310 may, in response to detecting a safety violation, send a message to the computing device. For example, the sent message may read “Emergency Exit 1 blocked.” Additionally or alternatively, the processor 310 may, in response to detecting resolution of the safety violation, send a message to the computing device. For example, the sent message may read “Emergency Exit 1 unblocked.” In some embodiments, the processor 310 may generate messages or notifications based on deterministic algorithms. For example, a message such as “Emergency Exit 1 Blocked” may be generated by following a deterministic algorithm, namely “Emergency Exit [identifier] [state].” In some embodiments, the processor 310 may generate the message or notification via a LLM included in the at least one AI application 340. For example, an AI application that detected the safety violation may also be an LLM. In this example, the textual or human-language output of the LLM upon detection of the safety violation, may be sent to the computing device as the message.

In some embodiments, the message or notification may be an audio message. In another embodiment, the processor 310 may generate a text or string message. Further, in some embodiments, the processor 310 may attach video data or image data to the generated message or notification. For example, in the case of a detected tripping hazard, the processor 310 may attach an image identifying the tripping hazard to the generated message.

The management module 326 may further comprise instructions that allow the processor 310 to interact with or access physical systems related to or associated with the monitored environment. For example, in response to detecting a blocked emergency exit in a building, the processor 310 may cause a speaker in the security room of the building to output “Emergency Exit blocked.” Additionally or alternatively, in response to detecting a safety violation, the processor 310 may cause an alarm, such as an alarm in a building, to be activated.

The reporting module 328 may comprise instructions that allow the processor 310 to generate reports with respect to detected safety violations or alert conditions. Subject matter of the generated report may include timestamps for detection of safety violations or alert conditions and timestamps for detected resolutions thereof. The subject matter may further include observed patterns. For example, a particular type of safety violation or alert condition may take longer than other types to be resolved. In another example, safety violations or alert conditions in a specific location may take longer to resolve than at other locations. The generated report may be reviewed to identify methods to improve safety in the monitored environment. In some embodiments, the processor 310 may, for the purpose of generating the report, call or otherwise access the at least one AI application 340.

FIG. 3 further shows the computer system 300 including a network interface 330. The network interface may facilitate wired or wireless communication with an external system or network (e.g., a PTT network, cellular network, an intranet, the Internet, a P2P network, a WAN, a LAN). For example, the network interface may allow the processor 310 to communicate with the computing device 110, the monitoring system 120, or the sensor system 122 (see FIG. 1).

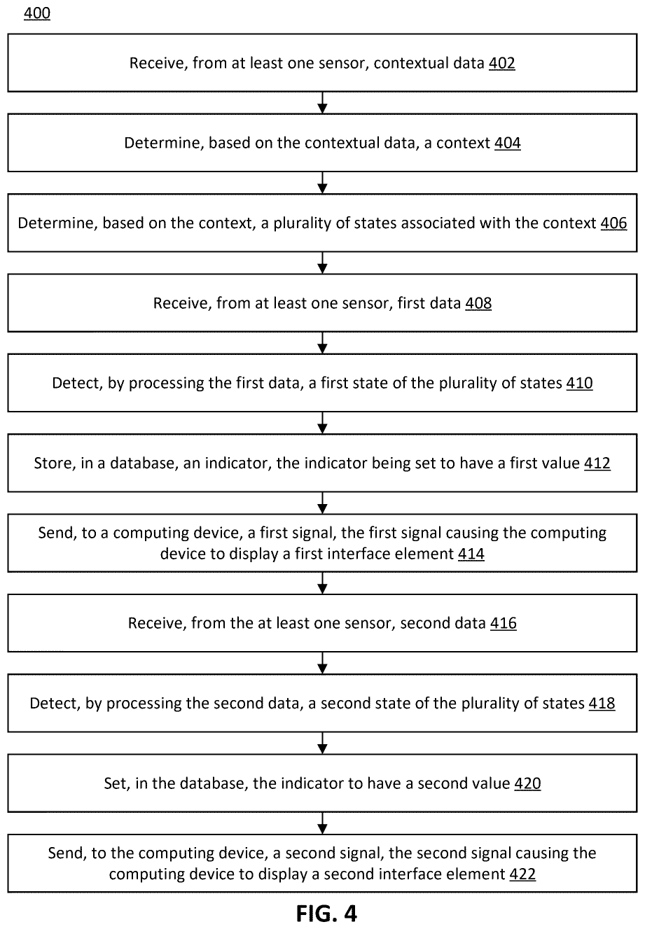

Reference is now made to FIG. 4 which shows, in flowchart form, a method 400 for managing an alert in response to detecting a safety violation or alert condition in a monitored environment. The method 400 may be performed by a computer system that supports a surveillance or monitoring system such as the computer system 100 or the computer system 300 (see FIGS. 1 and 3). The computer system may have a memory storing computer executable instructions for the processor to execute operations of the method 400.

The method 400 may begin with an operation 402. At the operation 402, the processor may receive, from at least one sensor deployed in a monitored environment, contextual data. The monitored environment may be, for example, an industrial facility, a healthcare facility, an educational facility, a commercial facility, a chemical facility, an office building, a factory, a laboratory, a power plant, a constructions site, or a workshop. The at least one sensor may include, without limitation, cameras, image capturing devices, video capturing devices, depth sensing devices, computer-vision cameras with depth sensing, audio recorders, temperature sensors, infrared sensors, moisture sensors, pressure sensors, smoke sensors, air quality sensors, chemical sensors, light sensors, touch sensors, motion sensors, proximity sensors, capacitive proximity sensors, inductive proximity sensors, ultrasonic proximity sensors, optical sensors, hall effect sensors, RFID readers, wearable devices, wearable sensors, and wearable PPE detection sensors. The contextual data may include, without limitation, image and video data from cameras, image capturing devices, or video capturing devise, depth data from depth capturing devices such as depth sensing cameras, infrared data from infrared sensors or other infrared capturing devices, audio data from audio recorders, temperature or heat data from heat sensors or temperature sensors, moisture data from moisture sensors, pressure data from pressure or touch sensors, light or optic data from light sensors or optic sensors, chemical data from smoke sensors or other chemical sensors such as air quality sensors, motion data from motion sensors, RFID data from RFID readers, proximity data from proximity sensors such as capacitive proximity sensors, inductive proximity sensors, ultrasonic proximity sensors, and hall effect sensors. In some embodiments, the processor may receive the contextual data from one of the at least one sensor(s) over a network such as the network 140 (see FIG. 1). For example, a camera may communicate image data to the processor over a network.

Following the operation 402, the method 400 may proceed to an operation 404. At the operation 404, the processor may determine, based on the contextual data, a context. The context may be a context relating to the monitored environment. For example, the context may be or correspond to, without limitation, monitoring of an emergency exit, monitoring of a walkway, a hallway, and/or monitoring of PPE monitoring. In some embodiments, the processor may determine the context by providing at least a portion of the contextual data to a ML model such as a model included in the at least one AI application 340 (see FIG. 3). That is, the ML model may output a context given contextual data. In other words, it may be said that determining the context further comprises providing at least a portion of the contextual data to a machine learning model that has been trained to determine the context.

Following the operation 404, the method 400 may proceed to an operation 406. At the operation 406, the processor may determine, based on the context, a plurality of states associated with the context. For example, in the case that the context is monitoring of an emergency exit, one of the plurality of states may correspond to the emergency exit being blocked and another one of the plurality of states may correspond to the emergency exit being unblocked. In another example, in the case that the context is monitoring of a hallway, one of the plurality of states may correspond to a tripping hazard in the walkway and another one of the plurality of states may correspond to a lack of tripping hazards in the walkway, In yet another example, in the case that the context is monitoring of PPE, one of the plurality of states may correspond to correct configuration of PPE and another of the plurality of states may correspond to incorrect configuration of PPE. In some embodiments, the processor may determine the plurality of states may be predefined relative to the context. That is, there may be a mapping that maps contexts to pluralities of states. For example, there may be a mapping that maps the context of monitoring an emergency exit to a plurality of states comprising a blocked state and an unblocked state. In this example, the mapping may also map the context of monitoring PPE to a plurality of states comprising “correct” and “incorrect.” Such a mapping may be stored, in for example, a database such as the database 130 (see FIG. 1). In another embodiment, the processor may use a ML model to determine the plurality of states. For example, the processor may provide the context to the ML model and the ML model may then in turn generate a plurality of states associated with the context. Additionally or alternatively, determining the plurality of states may be part of determining the context in the operation 404. For example, the processor may provide the contextual data to the ML model. In response there to, the ML model may output the context along with a plurality of states associated with the context.

Following the operation 406, the method 400 may proceed to an operation 408. At the operation 408, the processor may receive, from the at least one sensor deployed in the monitored environment, first data. The first data may include, without limitation, image and video data from cameras, image capturing devices, or video capturing devise, depth data from depth capturing devices such as depth sensing cameras, infrared data from infrared sensors or other infrared capturing devices, audio data from audio recorders, temperature or heat data from heat sensors or temperature sensors, moisture data from moisture sensors, pressure data from pressure or touch sensors, light or optic data from light sensors or optic sensors, chemical data from smoke sensors or other chemical sensors such as air quality sensors, motion data from motion sensors, RFID data from RFID readers, proximity data from proximity sensors such as capacitive proximity sensors, inductive proximity sensors, ultrasonic proximity sensors, and hall effect sensors. In some embodiments, the processor may receive the first data from one of the at least one sensor(s) over a network such as the network 140. For example, a wearable PPE detection sensor may communicate captured PPE detection data such as RFID data, image data, or infrared data to the processor over a network.

Following the operation 408, the method 400 may proceed to an operation 410. At the operation 410, the processor may detect, by processing the first data, a first state of the plurality of states. Since the plurality of states are associated with the context, it may be said that the first state is also associated with the context. In some embodiments, the first state may be considered an unresolved safety violation or alert condition relating to the context. For example, the first state may be or correspond to, without limitation, blockage of an emergency exit, a presence of a tripping hazard in a walkway or hallway, or missing or an incorrect configuration of PPE. In some embodiments, the processor may use AI and/or computer-vision to process and detect the first state. For example, the processor may call or prompt an ML model to determine the presence of a safety violation or alert condition based on the first data received from the at least one sensor. That is, processing the first data may further comprise passing at least a portion of the first data to a ML model that has been trained to detect the first state or corresponding safety violations or alert conditions. In another example wherein the first data includes image data, the processor may use a computer-vision application to process the image data and determine the presence of a safety violation or alert condition. That is, processing the first data may further comprise using a computer-vision application to detect the first state based on the first data. In another example, the processor may call or prompt an LLM or MLLM to determine the presence of a safety violation or alert condition. In this example, the LLM or MLLM may output text describing a safety violation, alert condition, or lack thereof.

In some embodiments, prior to receiving the first data from the at least one sensor in the operation 408, or prior to initiating execution of the method 400, the processor may train or fine-tune AI models such as an ML model, genAI model, LLM, or MLLM for the purposes of detecting safety violations or alert conditions in the operation 410. For example, the processor may use a plurality of data pairs to train or fine-tune a ML model wherein at least one of the plurality of data pairs includes a sample dataset and a sample value corresponding to the sample dataset. The sample dataset may be sample sensor data corresponding to a safety violation or alert condition. Additionally or alternatively, the sample dataset may be sample sensor data corresponding to a lack of a safety violation or alert condition. In another example, the processor may use a plurality of data pairs to train or fine-tune a ML model wherein at least one of the plurality of data pairs includes a first sample dataset corresponding to a first sample value and a second sample data second corresponding to a second sample value. The first sample dataset may be sample sensor data corresponding to a safety violation or alert condition. The second sample dataset may be sample sensor data corresponding to a resolution of the same safety violation or alert condition.

It should be appreciated that in some embodiments, the first data and the contextual data may overlap. That is, the processor may determine the context and detect the first data based on overlapping data obtained from the at least one sensor deployed in the monitored environment.

Following the operation 410, the method 400 may proceed to an operation 412. At the operation 412, the processor may store, in a database such as the database 130, an indicator (see FIG. 1). The indicator may be set to have a first value. Storing the indicator may be considered part of generating, storing, or creating a database entry corresponding to the detected first state, safety violation, or alert condition. For example, the processor may store in the database, a database entry comprising a description, classification, or code corresponding to the first state and a timestamp for its detection. The database entry may further include an indicator or variable that represents that the detected safety violation or alert condition is unresolved. For example, setting the indicator to have a value of “active,” 1, or “open” may represent that the first state, safety violation, or alert condition is unresolved. In a specific example, a database entry for a blocked emergency exit may have an indicator set to 1 until the emergency exit is unblocked.

In some embodiments, prior to storing the indicator or database entry in the database, the processor may determine a type of the detected safety violation or alert condition corresponding to the first state. For example, at the operation 410, the processor may generate using a ML model such as a classifier to generate a code that describes the type of safety violation or alert condition. In a specific example such as managing alerts for PPE, the processor may, at the operation 410, generate a code such as “57135:G” wherein “57135” is an employee or worker identifier and “G” represents missing or incorrectly using safety gloves. In another specific example such as monitoring an emergency exit, the processor may, at the operation 410, perhaps using a LLM, generate a textual description such as “Emergency Exit 1 Blocked.” At the operation 412, the description, classification, or code that is generated as part of determining the type of the detected safety violation or alert condition may be stored, along with the indicator, in a database entry in the database.

The method 400 further includes an operation 414. At the operation 414, the processor sends, to a computing device such as the computing device 110, a first signal (see FIG. 1). The first signal may cause the computing device to display a first interface element indicating that the indicator has the first value. That is, the first interface element communicates the detection of the first state to the computing device or a user thereof. Put another way, the first interface element communicates that a detected safety violation or alert condition is unresolved. In some embodiments, the processor may send the signal to the computing device over a network such as the network 140. In a specific example, the first interface element may correspond to the message or notification “Emergency Exit 1 blocked” being displayed on, for example, a handheld computing device. In another specific example, the first interface element may correspond to text presented on a user interface of an application maintained by the computer system and installed on the computing device wherein the text reads “Tripping Hazard in Hallway 2.” In some embodiments, the computing device may be associated with a particular person, worker, or employee. For example, in the case of PPE monitoring, the computing device that the first signal is sent to may be associated with a particular person such as a construction site worker. Additionally or alternatively, the computing device may not be associated with a particular person. For example, in the case of monitoring a building, the computing device may be a computer in a security room of the building.

In some embodiments wherein the first interface element comprises text, the processor may generate the text using a deterministic algorithm. For example, the message “Emergency Exit 1 blocked” may be generated using the template “Emergency Exit [identifier] [state].” In other embodiments wherein the first interface element comprises text, the processor may generate the text using a LLM. For example, in an embodiment where a LLM is used at the operation 404 to detect a safety violation or alert condition, the LLM may generate text describing the safety violation or alert condition. At least a portion of the generated text may be part of the first interface element.

It should be appreciated that the processor may execute both the operation 412 and the operation 414 in response to the operation 410. That is, the processor may, in response to detecting the first state, 1) store, in the database, the indicator, the indicator being set to have the first value, and 2) send, to the computing device, the first signal, the first signal causing the computing device to display the first interface element indicating that the indicator has the first value. Further, in some embodiments, the processor may execute or perform the operations 412 and 414 simultaneously or near-simultaneously. It should also be appreciated that the processor may execute or perform the operations 408 to 414 in real-time. That is, the processor may receive the first data from the at least one sensor, detect the first state by processing the first data, set the indicator to have the first value, store the set indicator, and send the first signal to the computing device in real-time.

Following the operation 414, the method 400 may proceed to an operation 416. At the operation 416, the processor may receive, from the at least one sensor, second data. The operation 416 may be similar to the operation 408. For example, the nature of the second data may be similar to the nature of the first data (i.e. type).

Following the operation 416, the method 400 may proceed to an operation 418. At the operation 418, the processor may detect, by processing the second data, a second state of the plurality of states, or alternatively, a progression from the first state to the second state of the plurality of states. In some embodiments, the second state may correspond to or represent the detected safety violation or alert condition being remedied, corrected, or resolved. In an example wherein the first state corresponds to a blocked emergency exit, the second state may correspond to the emergency exit being unblocked. Similar to the operation 410, the processor may use AI, an ML model, a genAI model, a LLM, a MLLM, or a computer-vision application to process the second data and detect the second state.

Following the operation 418, the method 400 may proceed to an operation 420. At the operation 420, the processor may set, in the database, the indicator to have a second value. The second value may represent that the alert condition or safety violation has been remedied, corrected, or resolved. For example, setting the indicator to have a value of “inactive,” 0, or “closed,” may represent remedy, correction, or resolution of the safety violation or alert condition, or alternatively, progression from the first state to the second state. In a specific example wherein an indicator has been set to 1 indicate that an emergency exit remains blocked, upon detecting the emergency exit becoming unblocked, the processor may set the indicator to have a value of 0.

The method 400 further includes an operation 422. At the operation 422, the processor may send, to the computing device, a second signal. The second signal may cause the computing device to display a second interface element indicating that the indicator has the second value. That is, the second interface element communicates the progression from the first state to the second state to the computing device or a user thereof. Put another way, the first interface element communicates that a detected safety violation or alert condition has been resolved. In some embodiments, the processor may send the signal to the computing device over a network. In a specific example, the second interface element may correspond to the message or notification “Emergency Exit 1 unblocked” being displayed on, for example, a handheld computing device. In another specific example, the second interface element may correspond to a checkmark appearing beside text presented on a user interface of an application maintained by the computer system and installed on the computing device wherein the text reads “Tripping Hazard in Hallway 2.”

Similar to the first interface element of the operation 414, in embodiments wherein the second interface element comprises text, the processor may use a deterministic algorithm or LLM to generate the text.

It should be appreciated that the processor may execute both the operation 420 and the operation 422 in response to the operation 418. That is, the processor may, in response to detecting the first state, 1) set, in the database, the indicator to have the second value, and 2) send, to the computing device, the second signal, the second signal causing the computing device to display the second interface element indicating that the indicator has the second value. Further, in some embodiments, the processor may execute or perform the operations 420 and 422 simultaneously or near-simultaneously. It should also be appreciated that the processor may execute or perform the operations 416 to 422 in real-time. That is, the processor may receive the second data from the at least one sensor, detect the second state by processing the second data, set the indicator to have the second value, and send the second signal to the computing device in real-time.

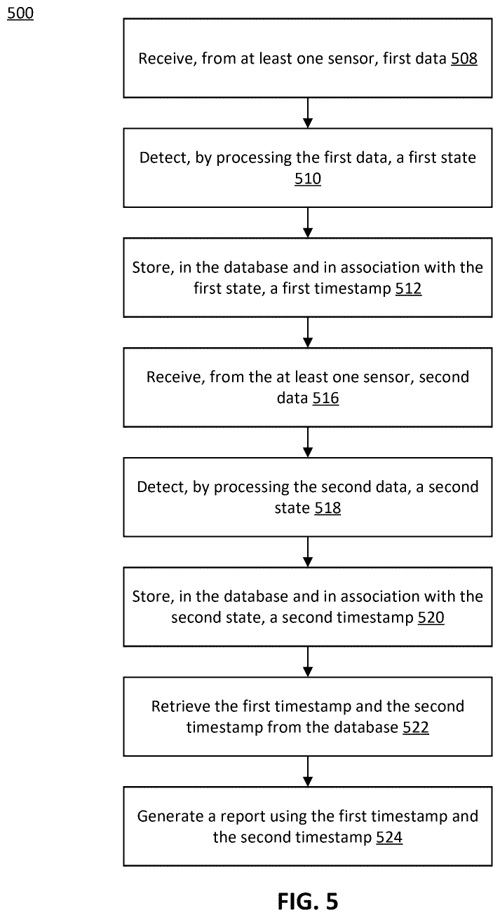

Reference is now made to FIG. 5 which shows, in flowchart form, a method 500 for recording timestamps relating to safety violations or alert conditions and generating reports pertaining to the same. In some embodiments, the method 500 may be executed or performed simultaneously and/or overlappingly with the method 400 (see FIG. 4). The method 500 may be performed by a computer system that supports a surveillance or monitoring system such as the computer system 100 or the computer system 300 (see FIGS. 1 and 3). The computer system may have a memory storing computer executable instructions for the processor to execute operations of the method 500.

The method 500 begins with an operation 508. At the operation 508, the processor may receive, from at least one sensor deployed around a monitored environment, first data. The operation 508 may be similar to the operation 408 of the method 400 as described herein with reference to FIG. 4.

Following the operation 508, the method 500 may proceed to an operation 510. At the operation 510, the processor may detect, by processing the first data, a first state. The operation 510 may be similar to the operation 410 of the method 400 as described herein with reference to FIG. 4.

Following the operation 510, the method 500 may proceed to an operation 512. At the operation 512, the processor may store, in response to detecting the first state, in a database such as the database 130, and in association with the first state, a first timestamp (see FIG. 1). The first timestamp may correspond to the time of detecting the first state. In embodiments wherein the processor is simultaneously or overlappingly executing the method 400 and the method 500, the processor may perform the operation 512 simultaneously or near-simultaneously with the operations 412 and 414 (see FIG. 4).

Following the operation 512, the method 500 may proceed to an operation 516. At the operation 516, the processor may receive, from the at least sensor, second data. The operation 516 may be similar to the operation 416 of the method 400 as described herein with reference to FIG. 4.

Following the operation 516, the method 500 may proceed to an operation 518. At the operation 518, the processor may detect, by processing the second data, a second state, or in the alternative, a progression from the first state to the second state. The operation 518 may be similar to the operation 418 of the method 400 as described herein with reference to FIG. 4.

Following the operation 518, the method 500 may proceed to an operation 520. At the operation 520, the processor may store, in response to detecting the second state, in the database and in association with the second state, a second timestamp. The second timestamp may correspond to the time of detecting the second state or progression from the first state to the second state. In embodiments wherein the processor is simultaneously or overlappingly executing the method 400 and the method 500, the processor may perform the operation 520 simultaneously or near-simultaneously with the operations 420 and 422 (see FIG. 4).

Following the operation 520, the method 500 may proceed to the operation 522. At the operation 522, the processor may retrieve the first timestamp and the second timestamp from the database. As implied in FIG. 5, the processor may execute the operation 522 subsequent to the operation 510.

Following the operation 522, the method 500 may proceed to the operation 524. At the operation 524, the processor my generate a report using the first timestamp and the second timestamp. It should be appreciated that the operations 522 and 524 relate to generating a report and that the generated report may relate to timestamps and detected safety violations and alert conditions beyond the safety violation or alert condition detected at the operation 510. For example, after an elapse of a time period, such as a week, the database may have stored therein data entries for a plurality of detected safety violations and alert conditions over that time period. The first timestamp and the second timestamp may be retrieved at the operation 522 along with other data such as other timestamps associated with other safety violations or alert conditions. The retrieved data may be used to generate the report. That is, the processor may generate the report based on the retrieved data or data stored in the database including the first timestamp and the second timestamp. The report may include, for example, and without limitation, all detected safety violations and alert conditions within a defined time period, all detected safety violations and alert conditions within a defined time period and of a particular type, the amount of time that it took to remedy, correct, or resolve a detected safety violation or alert condition, contexts of the detected safety violations and alert conditions, tabulation or summary of common types of safety violations or alert conditions, and tabulation or summary of safety violations or alert conditions that take longer to resolve than others.

In some embodiments, the processor may generate the report using AI such as an ML model, genAI model, a LLM, or a MLLM. For example, the processor may pass data retrieved from the database, such as the first timestamp and the second timestamp, to a genAI model and prompt the genAI model generate a report that summarizes the passed data.

Following generation of the report, the report may be reviewed to identify or determine ways to reduce the occurrence of safety violations or alert conditions, ways to reduce the time it takes to remedy, correct, or resolve a safety violation or alert condition, or otherwise enhance safety of the monitored environment. In some cases, a human may review or analyze the report. In other cases, the processor may use AI to review or analyze the report. For example, the report may be passed to an LLM which is in turn prompted to identify or determine a way to enhance safety of the monitored environment. Additionally or alternatively, in another embodiment, the processor may directly pass data from the database to a genAI model and prompt the genAI model to identify or determine ways to enhance safety of the monitored environment.

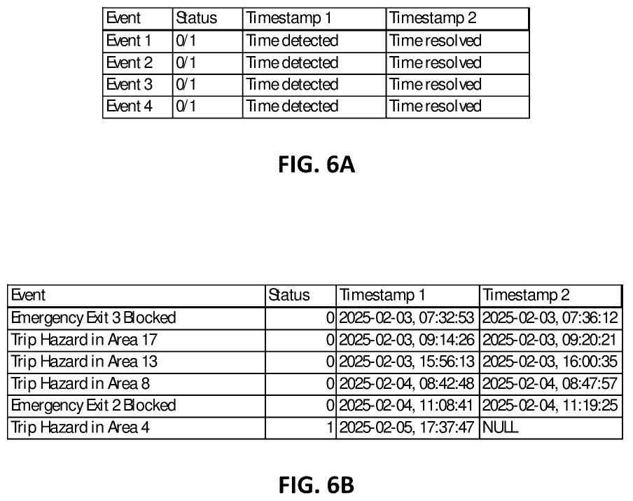

Reference is now made to FIGS. 6A and 6B which illustrate non-limiting database entries relating to safety violations or alert conditions detected in a monitored environment. FIG. 6A shows a template for such database entries. The database entries in FIG. 6A are a quadruple or have four fields. The first field is an “Event” field. The “Event” field may store a textual description of a detected safety violation or alert condition. The second field is a “Status” field. The “Status” field may correspond to the indicator referenced in the operations 406 and 414 of the method 400 (see FIG. 4). In the template of FIG. 6A, the “Status” field, or indicator, may store a value of 0 or 1. 0 may indicate that a safety violation or alert condition has been resolved. 1 may indicate that the safety violation or alert condition is unresolved. FIG. 6A further shows a “Timestamp 1” field. The “Timestamp 1” field may store a timestamp corresponding to detection of the safety violation or alert condition. Such a timestamp may be stored during an operation similar to the operation 506 of the method 500 as described herein with reference to FIG. 5. FIG. 6A further shows a “Timestamp 2” field. The “Timestamp 2” field may store a timestamp corresponding to the time the safety violation or alert conditions is remedied, corrected, or resolved. Additionally or alternatively, the “Timestamp 2” field may store a timestamp corresponding to the time that such remedy, correction, or resolution is detected. Such a timestamp may be stored during an operation similar to the operation 514 of the method 500 as described herein with reference to FIG. 5.

FIG. 6B shows example database entries adhering to the database entry template shown in FIG. 6A. As shown in FIG. 6B, the database entries have textual descriptions, such as “Emergency Exit 3 Blocked,” in their “Event” fields. The “Status” fields of the first to fifth database entries have a value of 0, thereby indicating that the corresponding safety violations or alert conditions have been resolved. On the other hand, the “Status” field of the sixth and last database entry has a value of 1, thereby indicating that the corresponding safety violation or alert condition is unresolved. Hence, in some embodiments, an alert relating to the sixth and last database entry may be considered “active.” FIG. 6B further shows timestamps in the “Timestamp 1” fields for all of the database entries. These timestamps indicate the time that the corresponding safety violation or alert condition was detected. In the case of the resolved first to fifth safety violations or alert conditions, the “Timestamp 2” fields of the corresponding data entries have stored therein timestamps. The sixth and last data entry has a “NULL” or null value for the “Timestamp 2” field as the corresponding safety violation or alert condition remains unresolved.

It should be appreciated that database entries such as those shown in FIG. 6B may be retrieved and used to generate a report as described with reference to the operations 516 and 518 of the method 500 (see FIG. 5).

It should be appreciated that the while FIG. 6A shows four database entries and FIG. 6B shows six database entries, FIGS. 6A and 6B are examples and the number of database entries stored in the database may be unlimited.

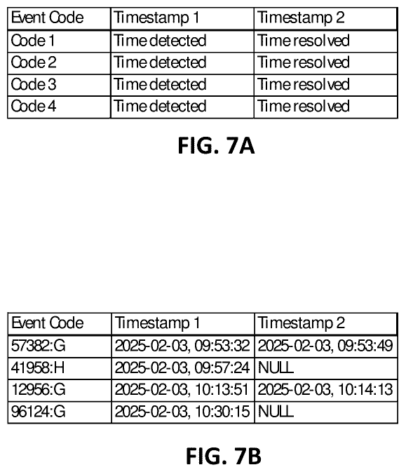

Reference is now made to FIGS. 7A and 7B which illustrate alternative non-limiting database entries relating to safety violations or alert conditions detected in a monitored environment. FIG. 7A shows a template for such database entries. The database entries in FIG. 7A are a triple or have three fields. The first field is an “Event Code” field. The “Event code” field may store a code representing or corresponding to a detected safety violation or alert condition. For example, in the case of PPE safety compliance, a code may comprise an identifier for a worker or employee and an identifier for a type of PPE violation. The second field is a “Timestamp 1” field. The “Timestamp 1” field of FIG. 7A may be similar to the “Timestamp 1” field of FIG. 6A as described herein. FIG. 7A further shows a “Timestamp 2” field. The “Timestamp 2” field of FIG. 7A may be similar to the “Timestamp 2” field of FIG. 6A as described herein. In the implementation of database entries shown in FIG. 7A, the “Timestamp 2” field may be used to indicate a status of the corresponding safety violation or alert condition. That is, the “Timestamp 2” field of FIG. 7A may server the functionality of both the “Timestamp 2” field and the “Status” field in FIG. 6A. For example, a timestamp being stored in the “Timestamp 2” field of FIG. 7A may be used to indicate that the corresponding safety violation or alert condition has been remedied, corrected, or resolved. Further, a “NULL” or null value being stored in the “Timestamp 2” field of FIG. 7A may be used to indicate that the corresponding safety violation or alert condition has not been remedied, corrected, or resolved.

FIG. 7B shows example database entries adhering to the database entry template shown in FIG. 7A. As shown in FIG. 7B, the database entries have codes, such as “57382:G” and “41958: H,” in their “Event” fields. In the implementation shown in FIG. 7B, the 5-digit number (e.g. 57382) may correspond to a worker or employee identifier and the letter after the colon may correspond to a type of safety violation or alert condition. For example, “G” may correspond to an employee or worker missing or incorrectly using safety gloves. In another example, “H” may correspond to an employee or worker missing or incorrectly using a helmet. FIG. 7B further shows timestamps in the “Timestamp 1” fields for all of the database entries. These timestamps indicate the time that the corresponding safety violation or alert condition was detected. FIG. 7B further shows timestamps stored in the “Timestamp 2” fields of the first and third database entries, thereby indicating that the safety violations or alert conditions corresponding to the first and third database entries are resolved. On the other hand, the second and fourth database entries each have a “NULL” or null value for the “Timestamp 2” field, thereby indicating that the corresponding safety violation or alert condition remains unresolved.

It should be appreciated that database entries such as those shown in FIG. 7B may be retrieved and used to generate a report as described with reference to the operations 516 and 518 of the method 500 (see FIG. 5).

It should be appreciated that the while FIGS. 7A and 7B show four database entries, FIGS. 7A and 7B are examples and the number of database entries stored in the database may be unlimited.

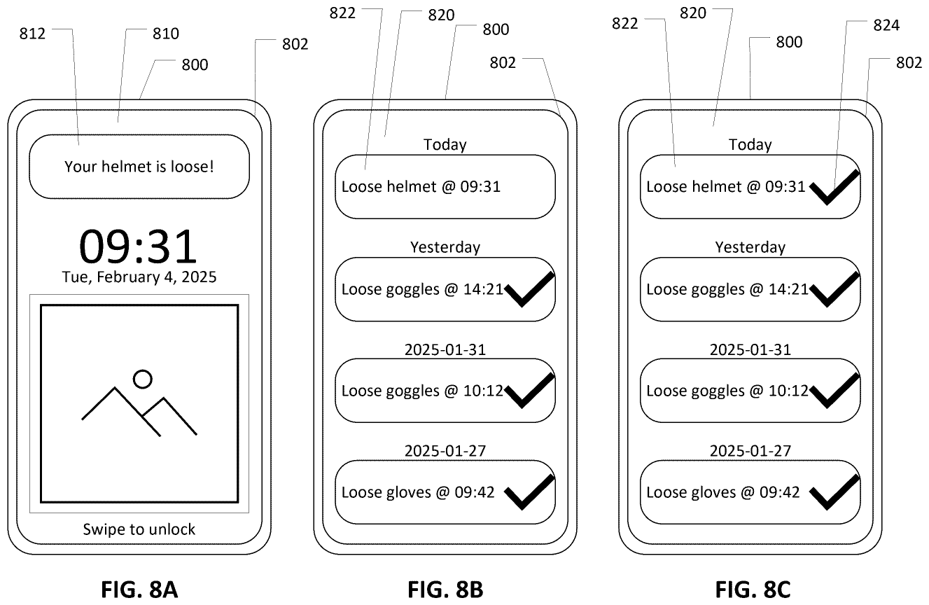

Reference is now made to FIGS. 8A-8C which show user interface elements for an alert management system or alert management application being displayed on a handheld device 800. In some embodiments, the handheld device 800 may be exemplary of the computing device 110 or the computing device 200 (see FIGS. 1 and 2). In some embodiments, the handheld device 800 may belong to or be associated with a person, worker, or employee. The handheld device 800 may have installed thereon, an application for alert management. In the example scenario shown in FIGS. 8A-8C, the application may relate to PPE monitoring for a particular person, worker, or employee.

FIG. 8A shows a display 802 of the handheld device 800 presenting a user interface 810 for a lockscreen of the handheld device 800. FIG. 8A further shows a notification message 812 reading “Your helmet is loose!” In some embodiments, the handheld device 800 may receive the notification message 812 in an operation similar to the operation 408 of the method 400 as described herein with reference to FIG. 4. For example, a signal similar to the first signal sent in the operation 408 may cause the handheld device 800 to display the notification message 812.

FIG. 8B shows the display 802 of the handheld device 800 presenting a user interface 820 for an application for managing alerts. The user interface 820 is shown including interface elements such as first interface element 822 that indicate or communicate a safety violation or alert condition to a user of the handheld device 800. The first interface element 822 is shown reading “Loose helmet @ 09:31” where 09:31 corresponds to the time that the safety violation (loose helmet) was detected. In some embodiments, the handheld device may display or present the first interface element 822 in response to receiving a signal in an operation similar to the operation 408 of the method 400 as described herein with reference to FIG. 4. For example, a signal similar to the first signal sent in the operation 408 may cause the handheld device 800 to display or present the first interface element 822.

FIG. 8C shows the display 802 of the handheld device 800 presenting the user interface 820. FIG. 8C may be considered an illustration of the user interface 820 after an unresolved safety violation or alert condition has been resolved. FIG. 8C shows a second interface element 824 (depicted as a checkmark), beside or overlayed on the first interface element 822. The presentation of the second interface element 824 beside or over the first interface element 822 may indicate or communicate to the user of the handheld device 800 that the safety violation or alert condition corresponding to the first interface element 822 has been resolved. In the example scenario illustrated in FIG. 8C, the second interface element 824 (checkmark) indicates that the safety violation or alert condition arising from the loose helmet detected at 09:31 is remedied, corrected, or resolved. In some embodiments, the handheld device 800 may display or present the second interface element 824 in response to receiving a signal in an operation similar to the operation 416 of the method 400 as described herein with reference to FIG. 4. For example, a signal similar to the second signal sent in the operation 416 may cause the handheld device 800 to display or present the second interface element 824.

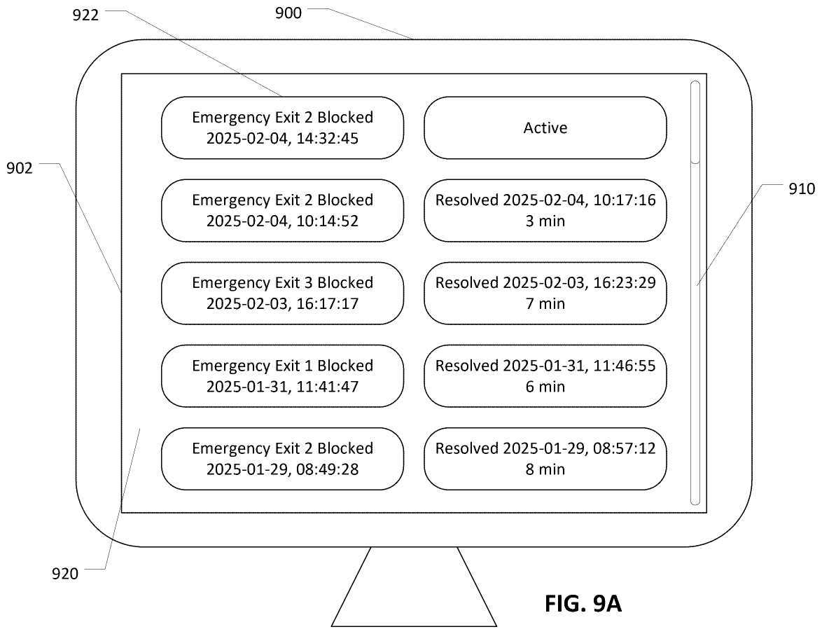

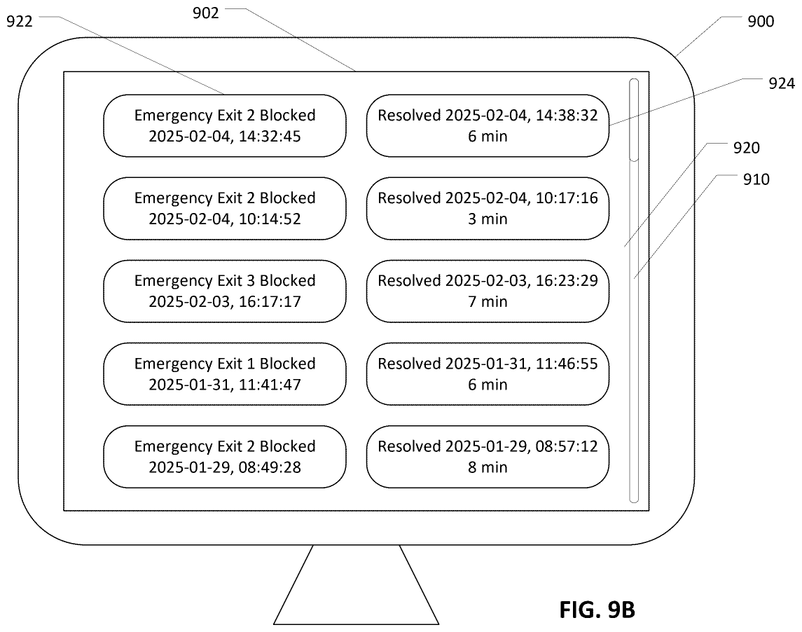

Reference is now made to FIGS. 9A and 9B which show user interface elements for an alert management system or alert management application being displayed on a monitor 900 of a computing device such as the computing device 110 or the computing device 200 (see FIGS. 1 and 2). In an example scenario, as described with reference to FIGS. 9A and 9B, the computing device may be a computer in a security room of a building. The computing device may have installed thereon, an application for alert management.

FIG. 9A shows a display 902 of the monitor 900 presenting a user interface 920 for an application for managing alerts. The user interface 920 is shown including interface elements such as first interface element 922 that indicate or communicate a safety violation or alert condition to a user of the computing device. The first interface element 922 is shown reading “Emergency Exit 2 Blocked 2025-02-04, 14:32:45″ where ”2025-02-04, 14:32:45″ corresponds to the time that the safety violation (emergency exit blockage) was detected. In some embodiments, the computing device or monitor 900 may display or present the first interface element 922 in response to receiving a signal in an operation similar to the operation 408 of the method 400 as described herein with reference to FIG. 4. For example, a signal similar to the first signal sent in the operation 408 may cause the computing device or monitor 900 to display or present the first interface element 922. The user interface 920 is further shown including a scrolling bar 910. Scrolling, via the scrolling bar 910, may allow a user of the computing device to view more alerts or descriptions relating to safety violations or alert conditions than presented on the display 902. For example, in the example scenario shown in FIG. 9A, the interface elements are sorted by reverse chronological order based on detection of the corresponding safety violation or alert condition. Using the scrolling bar 910 to scroll down would allow a user to view interface elements relating to safety violations or alert conditions that were detected earlier than those currently shown on the display 902.

FIG. 9B shows the display 902 of the monitor 900 presenting the user interface 920. FIG. 9B may be considered an illustration of the user interface 920 after an unresolved safety violation or alert condition has been resolved. FIG. 9B shows a second interface element 924 beside the first interface element 922. The presentation of the second interface element 924 beside the first interface element 922 may indicate or communicate to the user of the computing device that the safety violation or alert condition corresponding to the first interface element 922 has been resolved. In the example scenario illustrated in FIG. 9B, the second interface element 924, reading “Resolved 2025-02-04, 14:38:32 6 min” indicates that the safety violation or alert condition arising from the emergency exit blockage at 2025-02-04, 14:32:45 was remedied, corrected, or resolved at 2025-02-04, 14:38:32, or six minutes after the detection of the emergency exit blockage. In some embodiments, the computing device may display or present the second interface element 924 in response to receiving a signal in an operation similar to the operation 416 of the method 400 as described herein with reference to FIG. 4. For example, a signal similar to the second signal sent in the operation 416 may cause the computing device to display or present the second interface element 924.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method performed by a context-aware system, the method comprising:
receiving, from at least one sensor deployed in a monitored environment, contextual data;
determining, based on the contextual data, a context of the monitored environment;
determining, based on the context, a plurality of states associated with the context;
receiving, from the at least one sensor, first data;
detecting, in relation to the monitored environment and by processing the first data, a first state of the plurality of states;
in response to detecting the first state:
storing, in a database, an indicator, the indicator being set to have a first value; and
sending, to a computing device, a first signal, the first signal causing the computing device to display a first interface element indicating that the indicator has the first value;
receiving, from the at least one sensor, second data;
detecting, by processing the second data, a progression from the first state to a second state of the plurality of states; and
in response to detecting the progression from the first state to the second state:
setting, in the database, the indicator to have a second value; and
sending, to the computing device, a second signal, the second signal causing the computing device to display a second interface element indicating that the indicator has the second value.

2. The computer-implemented method of claim 1 wherein determining the context further comprises providing at least a portion of the contextual data to a machine learning model that has been trained to determine the context.

3. The computer-implemented method of claim 1 wherein processing the first data further comprises providing at least a portion of the first data to a machine learning model that has been trained to detect the first state.

4. The computer-implemented method of claim 3 wherein the method further comprises, prior to receiving the first data, using a plurality of data pairs to train the machine learning model, one of the plurality of data pairs including a sample dataset and a sample value corresponding to the sample dataset.

5. The computer-implemented method of claim 3 wherein the method further comprises, prior to receiving the first data, using a plurality of data pairs to train the machine learning model, one of the plurality of data pairs including a first sample dataset corresponding to a first sample value and a second sample dataset corresponding to a second sample value.

6. The computer-implemented method of claim 1 wherein processing the first data further comprises using a computer-vision application to detect the first state based on the first data.

7. The computer-implemented method of claim 1 wherein the at least one sensor includes a wearable sensor.

8. The computer-implemented method of claim 1 wherein the context corresponds to monitoring of an emergency exit and the first state corresponds to blockage of the emergency exit.

9. The computer-implemented method of claim 1 wherein the context corresponds to monitoring of a walkway and the first state corresponds to a presence of a tripping hazard in the walkway.

10. The computer-implemented method of claim 1 wherein the context corresponds to monitoring of personal protective equipment and the first state corresponds to incorrect configuration of the personal protective equipment.

11. The computer-implemented method of claim 1 wherein the method further comprises:
storing, in response to detecting the first state, in the database and in association with the first state, a first timestamp;
storing, in response to detecting the second state, in the database and in association with the second state, a second timestamp;
retrieving, subsequent to storing the second timestamp, the first timestamp and the second timestamp from the database; and
generating a report using the first timestamp and the second timestamp.

12. A context-aware computer system, the computer system comprising:
a processor; and
a memory coupled to the processor, the memory storing computer-readable instructions that, when executed by the processor, configure the processor to:
receive, from at least one sensor deployed in a monitored environment, contextual data;
determine, based on the contextual data, a context of the monitored environment;
determining, based on the context, a plurality of states associated with the context;
receive, from the at least one sensor, first data;
detect, in relation to the monitored environment and by processing the first data, a first state of the plurality of states;
in response to detecting the first state:
store, in a database, an indicator, the indicator being set to have a first value; and
send, to a computing device, a first signal, the first signal causing the computing device to display a first interface element indicating that the indicator has the first value;
receive, from the at least one sensor, second data;
detect, by processing the second data, a progression from the first state to a second state of the plurality of states; and
in response to detecting the progression from the first state to the second state:
set, in the database, the indicator to have a second value; and
send, to the computing device, a second signal, the second signal causing the computing device to display a second interface element indicating that the indicator has the second value.

13. The computer system of claim 12 wherein the instructions further configure the processor to determine the context by providing at least a portion of the contextual data to a machine learning model that has been trained to determine the context.

14. The computer system of claim 12 wherein the instructions further configure the processor to process the first data by providing at least a portion of the first data to a machine learning model that has been trained to detect the first state.

15. The computer system of claim 14 wherein the instructions further configure the processor to, prior to receiving the first data, use a plurality of data pairs to train the machine learning model, one of the plurality of data pairs including a sample dataset and a sample value corresponding to the sample dataset.

16. The computer system of claim 14 where the instructions further configure the processor to, prior to receiving the first data, use a plurality of data pairs to train the machine learning model, one of the plurality of data pairs including a first sample dataset corresponding to a first sample value and a second sample dataset corresponding to a second sample value.

17. The computer system of claim 12 wherein the instructions further configure the processor to use a computer-vision application to detect the first state based on the first data.

18. The computer system of claim 12 wherein the at least one sensor includes a wearable sensor.

19. The computer system of claim 12 wherein the instructions further configure the processor to:
store, in response to detecting the first state, in the database and in association with the first state, a first timestamp;
store, in response to detecting the second state, in the database and in association with the second state, a second timestamp;
retrieve, subsequent to storing the second timestamp, the first timestamp and the second timestamp from the database; and
generate a report using the first timestamp and the second timestamp.

20. A non-transitory computer-readable storage medium storing computer readable instructions that when, executed by a processor, configure the processor to, in a context-aware manner:
receive, from at least one sensor deployed in a monitored environment, contextual data;
determine, based on the contextual data, a context of the monitored environment;
determine, based on the context, a plurality of states associated with the context;
receive, from at least one sensor, first data;
detect, in relation to the monitored environment and by processing the first data, a first state of the plurality of states;
in response to detecting the first state:
store, in a database, an indicator, the indicator being set to have a first value; and
send, to a computing device, a first signal, the first signal causing the computing device to display a first interface element indicating that the indicator has the first value;
receive, from the at least one sensor, second data;
detect, by processing the second data, a progression from the first state to a second state of the plurality of states; and
in response to detecting the progression from the first state to the second state:
set, in the database, the indicator to have a second value; and
send, to the computing device, a second signal, the second signal causing the computing device to display a second interface element indicating that the indicator has the second value.
